(19) United States
(12) Patent Application Publication
(10) Pub. No.: US 2021/0224632 A1
(43) Pub. Date: Jul. 22, 2021

(54) METHODS, DEVICES, CHIPS, ELECTRONIC APPARATUSES, AND STORAGE MEDIA FOR PROCESSING DATA

(71) Applicant: SHENZHEN SENSETIME TECHNOLOGY CO., LTD., SHENZHEN (CN)

(72) Inventors: Bo ZHOU, SHENZHEN (CN); Qingzheng LI, SHENZHEN (CN)

(21) Appl. No.: 17/222,095

(22) Filed: Apr. 5, 2021

Related U.S. Application Data
(63) Continuation of application No. PCT/CN2020/103075, filed on Jul. 20, 2020.

(30) Foreign Application Priority Data
Jan. 22, 2020 (CN) 202010074848.4

(51) Int. Cl. G06N 3/04; G06F 16/28; G06F 9/48

(52) U.S. Cl. CPC G06N 3/04; G06F 9/4843; G06F 16/285

(57) ABSTRACT

A method of processing data, includes: acquiring first to-be-processed data and an input-channels-number, wherein a channels-number of the first to-be-processed data is greater than the input-channels-number; processing the first to-be-processed data according to the input-channels-number so as to obtain second to-be-processed data, wherein a channels-number of the second to-be-processed data is less than or equal to the input-channels-number; obtaining a processing parameter; and processing the second to-be-processed data with the processing parameter so as to obtain first data. An electronic apparatus, a chip and a computer-readable storage medium are further provided.

### CROSS REFERENCES TO RELATED APPLICATIONS

The present application is a continuation application of International Patent application PCT/CN2020/103075 filed with the China National Intellectual Property Administration (CNIPA) on Jul. 20, 2020, which is based on and claims the priority to and benefits of CN 202010074848.4, entitled “METHODS, DEVICES, CHIPS, ELECTRONIC APPARATUSES, AND STORAGE MEDIA FOR PROCESSING DATA” and filed before CNIPA on Jan. 22, 2020. The contents of all of the above-identified applications are incorporated herein by reference in their entirety.

### TECHNICAL FIELD

The present disclosure relates to the field of computer technology, and more particularly, to methods, devices, chips, electronic apparatuses, and storage media for processing data.

### BACKGROUND

Thanks to their powerful processing capability, deep convolutional neural networks are widely applied in the fields of computer vision and of speech processing. Data processing of the deep convolutional neural network involves a large quantity of convolution operations. Because data processing volume of convolution operations is relatively large and a hardware, such as field programmable gate arrays (FPGA), application specific integrated circuits (ASIC) and graphics processing units (GPU), generally is limited in terms of bandwidth and power consumption, a processing efficiency of the hardware to execute an online reasoning process with the deep neural networks is relatively low. In order to improve the processing efficiency of the hardware, many deep neural network acceleration methods have emerged as time requires.

In conventional deep neural network acceleration methods, at least one data block is acquired from input data of each layer of a deep neural network, and each data block is subjected to a convolution operation executed by hardware in sequence, so as to improve the processing efficiency of the hardware. However, such methods have poor versatility.

### SUMMARY

The present disclosure provides methods, devices, chips, electronic apparatus, and storage media for processing data.

In the first aspect of the present disclosure, a method of processing data is provided, including:

acquiring first to-be-processed data and an input-channels-number, wherein a channels-number of the first to-be-processed data is greater than the input-channels-number;

processing the first to-be-processed data according to the input-channels-number so as to obtain second to-be-processed data, wherein a channels-number of the second to-be-processed data is less than or equal to the input-channels-number; and

acquiring a processing parameter; and

processing the second to-be-processed data so as to obtain first data.

In this aspect, the first to-be-processed data is processed according to the input-channels-number so as to obtain the second to-be-processed data of a channels-number less than or equal to the input-channels-number. In a case that the method according to the first aspect is applied to a chip, input data for the chip can be processed such that the first to-be-processed data of a channels-number greater than the number of input channels of the chip, is processed so as to obtain the second to-be-processed data of a channels-number less than or equal to the number of input channels of the chip. In this way, as the channels-number of the input data can be downed to be less than or equal to the number of input channels of the chip, the chip can process input data of any channels-number, thereby improving the versatility of the chip.

In a second aspect of the present disclosure, a device for processing data is provided, including:

an acquiring unit, configured to acquire first to-be-processed data and an input-channels-number, wherein a channels-number of the first to-be-processed data is greater than the input-channels-number;

a first processing unit, configured to process the first to-be-processed data according to the input-channels-number so as to obtain second to-be-processed data, wherein a channels-number of the second to-be-processed data is less than or equal to the input-channels-number;

the acquiring unit is further configured to acquire a processing parameter; and

a second processing unit, configured to process the second to-be-processed data with the processing parameter so as to obtain first data.

In a third aspect of the present disclosure, a chip is provided, and the chip is configured to implement the method according to the first aspect and any possible implementation manner thereof.

In a fourth aspect of the present disclosure, an electronic apparatus is provided, including: a chip, a processor, and memory configured to store computer program code which includes computer instructions, wherein in a case that the chip executes the computer instructions, the electronic apparatus implements the method according to the first aspect and any possible implementation manner thereof.

In a fifth aspect of the present disclosure, a computer-readable storage medium is provided, the computer-readable storage medium is configured to store a computer program which includes program instructions, wherein in a case that the program instructions are executed by a processor of an electronic apparatus, the program instructions cause the processor to implement the method according to the first aspect and any possible implementation manner thereof.

In a sixth aspect of the present disclosure, a computer program product containing instructions is provided, which, in a case that the computer program product is run on a computer, causes the computer to implement the method according to the first aspect and any possible implementation manner thereof.

It should be understood that the above general description and the following detailed description are only exemplary and explanatory, rather than limiting the present disclosure.

### BRIEF DESCRIPTION OF THE DRAWINGS

In order to more clearly illustrate the technical solutions in the embodiments of the present disclosure or the background art, the figures that need to be used in the embodiments of the present application or the background art will be described hereinafter.

The figures here are incorporated into the specification and constitute a part of the specification. These drawings illustrate embodiments in consistence with the present disclosure and are used together with the specification to illustrate the technical solutions of the present disclosure.

FIG. 1 illustrates a schematic flowchart of a method of processing data according to an embodiment of this present disclosure;

FIG. 2 illustrates a schematic structure of a chip according to an embodiment of the present disclosure;

FIG. 3 illustrates a schematic flowchart of a method of processing data according to another embodiment of the present disclosure;

FIG. 4 schematically illustrates splicing according to an embodiment of the present disclosure;

FIG. 5 schematically illustrates splicing according to another embodiment of the present disclosure;

FIG. 6 illustrates a schematic structure of a convolutional neural network according to an embodiment of this present disclosure;

FIG. 7 illustrates a schematic flowchart of a method of processing data according to yet another embodiment of the present disclosure;

FIG. 8 schematically illustrates a time division multiplexing cycle of a chip according to an embodiment of the present disclosure;

FIG. 9A schematically illustrates performing a convolution operation in a chip according to an embodiment of the present disclosure;

FIG. 9B schematically illustrates performing a convolution operation in a chip according to another embodiment of the present disclosure;

FIG. 10A schematically illustrates performing a convolution operation in a chip according to yet another embodiment of the present disclosure;

FIG. 10B schematically illustrates performing a convolution operation in a chip according to still another embodiment of the present disclosure;

FIG. 11 illustrates a schematic structure of a chip according to another embodiment of the present disclosure;

FIG. 12 illustrates a schematic structure of a chip according to yet another embodiment of the present disclosure;

FIG. 13 illustrates a schematic structure of a chip according to still another embodiment of the present disclosure; and

FIG. 14 illustrates a schematic structure of a device for processing data according to an embodiment of the present disclosure.

### DETAILED DESCRIPTION OF THE EMBODIMENTS

In order to enable one or ordinary skill in the art to understand the solution of the present disclosure better, the technical solutions according to the embodiments of the present disclosure will be clearly and thoroughly described hereinafter in conjunction with the drawings in the embodiments of the present disclosure. Obviously, the described embodiments are only a part of the embodiments of the present disclosure, rather than all of the embodiments of the present disclosure. Based on the embodiments of the present disclosure, all other embodiments obtained by one of ordinary skill in the art without any creative work shall fall within the protection scope of the present disclosure.

The terms “first”, “second”, etc. in the specification, the claims of the present disclosure and the above-mentioned drawings are intended to distinguish different objects, rather than to describe a specific sequence. In addition, the terms “include” and “comprise” and any variations thereof are intended to cover non-exclusive inclusion. For example, a process, method, system, product, or device that includes a series of steps or units is not limited to the listed steps or units, but optionally includes unlisted steps or units, or optionally further includes other steps or units inherent to these processes, methods, products or equipment.

The term “and/or” used herein is only an association relationship describing associated objects, which means that there can be three relationships, for example, A and/or B, which can mean three situations: A alone, both A and B at the same time, and B alone. In addition, the term “at least one” herein means any one or any combination of at least items of multiple items, for example, the expression “at least one of A, B, and C”, may mean any one or more elements selected in a group formed by A, B and C.

Reference to “embodiments” herein means that a specific feature, structure, or characteristic described in conjunction with the embodiments may be included in at least one embodiment of the present disclosure. The appearance of the phrase in various places in the specification does not necessarily refer to the same embodiment, nor is it an independent or alternative embodiment mutually exclusive with other embodiments. One of ordinary skill in the art understands clearly and implicitly that the embodiments described herein may be combined with other embodiments.

The executing subject of the embodiments of the present application is a device for processing data, and the device for processing data may be any one of the following: a chip, a mobile phone, a computer, a server, and a tablet computer.

The embodiments of the present application will be described hereinafter in conjunction with the drawings of the present disclosure.

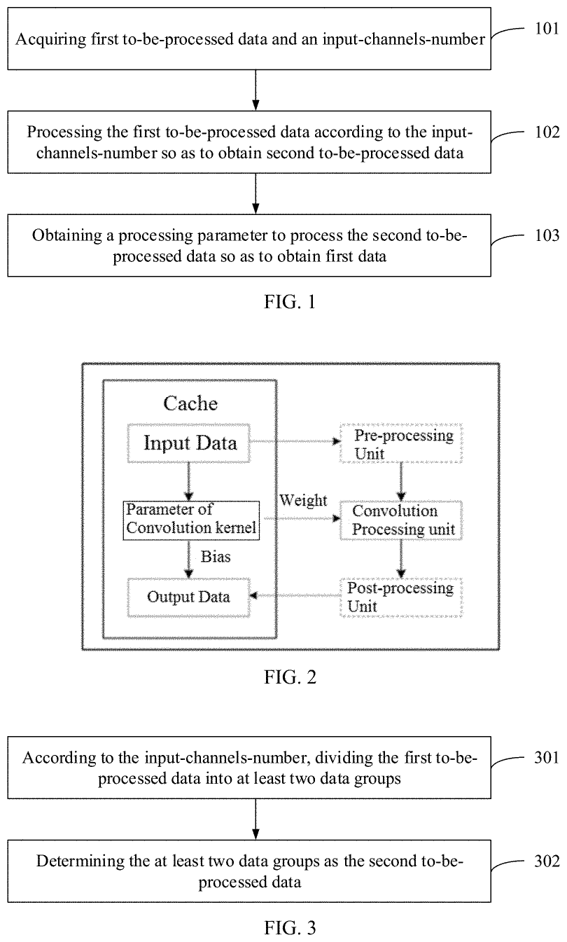

Please refer to FIG. 1, which illustrates a schematic flowchart of a method of processing data according to an embodiment of the present disclosure.

101. First to-be-processed data and an input-channels-number are acquired.

In the embodiment of the present disclosure, the first to-be-processed data may be images or voice data or sentences. The channels-number of the first to-be-processed data is greater than or equal to 1. For example, in a case that the first to-be-processed data is an image, the channels-number of the first to-be-processed data may be 3. For another example, in a case that the first to-be-processed data includes two voice data groups, and the channels-number of each voice data group is 2, the channels-number of the first to-be-processed data is two.

In this embodiment of the disclosure, the input-channels-number may be the number of input channels of the chip. The chip can be configured to implement a convolutional neural network. For example, the aforementioned chip may be an FPGA. For another example, the chip may be an ASIC. For another example, the chip may be a GPU.

In the embodiments of the disclosure, the channels-number of the first to-be-processed data is greater than the input-channels-number.

102. The first to-be-processed data is processed according to the input-channels-number so as to obtain second to-be-processed data.

The number of input channels of the chip is fixed, while the channels-number of data input to different convolutional layers of the convolutional neural network may be different. In a conventional method, different chips are used to achieve processing of different convolutional layers. For example, a convolutional neural network A includes a convolutional layer a and a convolutional layer b. The channels-number of data input to the convolutional layer a is 3, and the channels-number of data input to the convolutional layer b is 4. Assuming that the number of input channels of chip A is 3, the data input to the convolutional layer a may be processed by chip A. However, as the channels-number of data input to the convolutional layer b is greater than the number of input channels of chip A, the chip A cannot process data input to the convolutional layer b, and a chip with more input channels is required to process data input to the convolutional layer b. For example, the data input to the convolutional layer b may be processed by chip B with 4 input channels.

In the embodiment of the present disclosure, in the process of performing the processing of the convolutional layers of the convolutional neural network through the chip and layer by layer, it is determined whether the first to-be-processed data is to be processed according to the number of input channels of the chip and the channels-number of the data input to the convolutional layer (in this embodiment, the data input to the convolutional layer is the first to-be-processed data). In a case that the first to-be-processed data is to be processed, the first to-be-processed data is processed so that the channels-number of processed data is less than or equal to the number of input channels of the chip. In this way, the processing of different convolutional layers may be implemented by a chip.

For example, the number of input channels of the chip is 2 and the first to-be-processed data includes an image with 3 channels. As the channels-number of the first to-be-processed data is greater than the number of input channels of the chip, it is impossible to input all the first to-be-processed data to the chip in one processing batch of the chip, and processing on the first to-be-processed data cannot be implemented by the chip. At this time, the first to-be-processed data is to be processed so that the channels-number of data obtained through processing is less than or equal to the number of input channels of the chip, thereby processing all the first to-be-processed data through at least two processing batches.

In a possible embodiment, through dividing the first to-be-processed data into n channels of data (n is less than or equal to the number of input channels of the chip), data input to the chip in a processing batch (i.e. the second to-be-processed data mentioned above) can be obtained. The first to-be-processed data is processed in this division manner, and the processing of all the first to-be-processed data can be implemented through at least two processing batches. For example, the first to-be-processed data includes two images, and the channels-number of each image is 3. The number of input channels of the chip is 4. Since the channels-number of the first to-be-processed data (i.e., 3+3=6) is greater than the number of input channels of the chip, the first to-be-processed data is to be divided. The first to-be-processed data can be divided into a second to-be-processed data a with 4 channels and a second to-be-processed data b with 2 channels. The chip processes the second to-be-processed data a through one processing batch and processes the second to-be-processed data b through another processing batch, so as to complete processing on the first to-be-processed data. Sequence of processing the second to-be-processed data a and processing the second to-be-processed data b is not limited in the present disclosure.

In another possible implementation manner, the channels-number of the first to-be-processed data is greater than or equal to 2. At least two channels of data in the first to-be-processed data are spliced, such that the channels-number of the first to-be-processed data is less than or equal to the number of input channels of the chip, and the spliced first to-be-processed data is obtained. The chip can implement processing on the spliced first to-be-processed data through one processing batch, that is, complete the processing on the first to-be-processed data. For example, the first to-be-processed data includes 4 channels of data, namely, first channel data, second channel data, third channel data, and fourth channel data. The number of input channels of the chip is 3. Fifth channel data is obtained by splicing the first channel data and the second channel data. The third channel data, the fourth channel data, and the fifth channel data are taken as the spliced first to-be-processed data. In this way, the channels-number of the spliced first to-be-processed data is 3. The chip can implement the processing on the spliced first to-be-processed data, that is, complete the processing on the first to-be-processed data, through one processing batch.

In this step, the first to-be-processed data is processed according to the input-channels-number so as to obtain the second to-be-processed data. The processing on input data with any channels-number can be completed through the chip, that is, convolution operation on input data of any number of convolutional layers can be achieved, thereby improving the versatility of the technical solution according to the present disclosure.

103. A processing parameter is obtained to process the second to-be-processed data so as to obtain first data.

In the embodiment of the present disclosure, the processing parameter includes a parameter of a convolution kernel, which includes a weight of the convolution kernel and a bias of the convolution kernel.

In one possible implementation, the chip has a structure as illustrated in FIG. 2. In this structure, the cache is configured to store input data (that is, the data that the chip needs to process in each processing batch), the parameter of the convolution kernel that the chip needs to use in each processing batch, and output data (that is, data obtained through the processing by the chip in each processing batch). The convolution processing unit of this structure is configured to perform a convolution operation on the input data and accumulate based on the weight of the convolution kernel, so as to obtain convolution-processed data. Output data may be obtained based on the bias of the convolution kernel and the convolution-processed data.

Optionally, the structure illustrated in FIG. 2 may include at least one of a pre-processing unit and a post-processing unit. The pre-processing unit may be configured to perform mathematical transformation on data, such as: converting time domain data into frequency domain data. The post-processing unit may be configured to perform mathematical transformation inverse to the mathematical transformation performed by the pre-processing unit, such as: converting frequency domain data into time domain data. The post-processing unit is further configured to perform other operations, such as pooling processing, interpolation processing, and implementing softmax functions, clipping data, adjusting the resolution of the data, etc. For example, the input data of the structure as illustrated in FIG. 2 is time domain data, and the input data can be converted into frequency domain data through processing the input data by the preprocessing unit. For another example, in a case that the output data of the convolution processing unit is an image with a size of 100*100, the post-processing unit can clip the image so as to obtain an image with a size of 50*50. For another example, the output data of the convolution processing unit is an image, and the resolution of the image can be improved by the post-processing unit.

The chip performs a convolution operation on the second to-be-processed data with the parameter of the convolution kernel, so as to obtain the first data.

Benefiting from processing input data according to the input channels of the chip, the chip can process input data of different channels-numbers. Applying the technical solution according to this embodiment to the chip can make the chip have good versatility.

Before proceeding to the following elaboration, first define a concept of “data processing volume threshold of a chip”. In the embodiment of the present disclosure, the data processing volume threshold of the chip refers to the maximum value of the data volume of an individual channel that the chip can process in a processing batch. For example, a chip with a data processing volume threshold of 8 kilobytes means that the data volume of an individual channel that can be processed by the chip in a processing batch is at most 8 kilobytes.

Due to the limited hardware resources of the chip, the processing capacity of the chip is limited in a processing batch, and data volume of the second to-be-processed data is relatively large, and when the data volume of the second to-be-processed data is greater than the data processing volume threshold of the chip, the chip cannot complete processing of the second to-be-processed data in one processing batch, and at least two processing batches are required to complete the processing on the second to-be-processed data. Since the data volume of the second to-be-processed data is usually large, and the storage space of the cache of the chip is usually small, and the second to-be-processed data is stored in an external memory (such as a memory of the chip). Before processing the second to-be-processed data, the chip reads the second to-be-processed data from the external memory and stores the second to-be-processed data in the cache. It should be noted that due to the hardware characteristics of the chip, the chip typically processes the data in the cache first and then the data in the memory. Therefore, in the process that the chip processes the second to-be-processed data, the chip may not read data other than the second to-be-processed data in the external memory. The chip may not read data from the external memory until the chip complete the processing of the second to-be-processed data stored in the cache. This will greatly reduce the reading efficiency of the chip, thereby reducing the processing efficiency of the chip.

For example, the first to-be-processed data is processed, so as to obtain the second to-be-processed data A and the second to-be-processed data B. During performing a convolution operation on the first to-be-processed data, the chip first reads the second to-be-processed data A from the external memory, and stores the second to-be-processed data A in the cache. A data block with data volume less than or equal to the data processing volume threshold of the chip is selected from the second to-be-processed data A stored in the cache as to-be-processed data in a first processing batch. During processing the to-be-processed data in the first processing batch, the cache of the chip no longer reads the second to-be-processed data B from the external memory. After the chip processes all the data in the second to-be-processed data A, the cache of the chip reads the second to-be-processed data B from the external memory. Obviously, affected by the hardware characteristics of the chip, the chip typically processes the data in the memory after all the data in the cache is processed. When the chip processes the second to-be-processed data A, the reading resource of the cache of the chip is in an idle state, which reduces the reading efficiency of the chip undoubtedly and greatly. For example, the data processing volume threshold is 10, and data volume of data contained in the chip cache is 15, in such a case, in one processing batch, the chip can process 10 units of data in parallel, and there are still 5 units of data in the cache that have not been processed, thus the chip will not read data from the external memory. For another example, the data processing volume threshold is 10, and volume of data contained in the chip cache is 10. In a processing batch, the chip can process 10 units of data in parallel. There is no data in the cache, the chip will read data from the external memory and process data.

In order to improve the reading efficiency of the chip, at least one embodiment of the present disclosure further provides another technical solution of processing the first to-be-processed data. Please refer to FIG. 3, which illustrates a schematic flowchart of a method of processing data according to another embodiment of the present disclosure.

301. According to the input-channels-number, the first to-be-processed data is divided into at least two data groups.

As described above, the input-channels-number is fixed, so the first to-be-processed data can be divided into at least two data groups, and the channels-number of each of the at least two data groups is less than or equal to the input-channels-number. For example (Example 1), the channels-number of the first to-be-processed data is 6, and the input-channels-number is 4. The first to-be-processed data can be divided into data A and data B, wherein the channels-number of the data A is 4, and the channels-number of the data B is 2. The first to-be-processed data can also be divided into data C and data D, wherein the channels-number of the data C and the channels-number of the data D are both 3. Optionally, data of the channels-number equal to the input-channels-number is preferably divided from the first to-be-processed data, so that the reading resources of the chip can be fully utilized and the reading efficiency of the chip can be improved. As described in in Example 1, the first to-be-processed data is divided into the data A and the data B.

In a case of dividing the first to-be-processed data, a data processing volume threshold of the chip is also taken into account in the embodiment, so as to make full use of the processing resources of the chip and improve the reading efficiency of the chip.

In order to make full use of the processing resources of the chip, data volume of the input data in each processing batch is required to be as close as possible to the data processing volume threshold of the chip. Since the data processing volume threshold of the chip is known, a data volume of each data group divided from the first to-be-processed data can be determined according to the data processing volume threshold of the chip, so that the data volume of an individual channel in each data group obtained through division is less than or equal to the data processing volume threshold.

In a possible embodiment, each channel of data in the first to-be-processed data is a two-dimensional matrix, and data volume of each element in the matrix is equal (for example, data volume of each pixel in the image are identical). According to the data processing volume threshold, a data set containing an optimal number of data sub-set (hereinafter referred to as an optimal data set) can be selected from at least one channel of data in the first to-be-processed data as third to-be-processed data. According to the input-channels-number, the third to-be-processed data are divided into at least two data groups. The at least two data groups are determined as the second to-be-processed data. Refer to the following example for the optimal number. Assuming the optimal number is h, data volume of h data sub-set is less than or equal to the data processing volume threshold of the chip, and the data volume of (h+1) data sub-set is greater than the data processing volume threshold of the chip. The h is a positive integer.

For example, the first to-be-processed data includes 3 channels of data, namely, first channel data, second channel data, and third channel data. The input-channels-number is 2. An optimal data set is selected from the first channel data so as to obtain fourth channel data. An optimal data set is selected from the second channel data so as to obtain fifth channel data. An optimal data set is selected from the third channel data so as to obtain sixth channel data. The fourth channel data, the fifth channel data, and the sixth channel data are taken as the third to-be-processed data. The third to-be-processed data is divided into data A and data B, where the data A includes the fourth channel data and the fifth channel data, and data B includes the sixth channel data.

In another possible embodiment, each channel of data in the first to-be-processed data are a two-dimensional matrix, and data volume of each element in the matrix is identical (for example, data volume of each pixel in the image is identical). According to the input-channels-number, the first to-be-processed data is divided into at least two fourth to-be-processed data set, wherein the channels-number of each fourth to-be-processed data set is less than or equal to the input-channels-number. According to the data processing volume threshold, a data set containing an optimal number of data (hereinafter referred to as the optimal data set) may be selected from at least one channel of data in the at least two fourth to-be-processed data set so as to obtain at least two data groups. The at least two data groups are determined as the second to-be-processed data.

For example, the first to-be-processed data includes 3 channels of data, namely, first channel data, second channel data, and third channel data. The input-channels-number is 2. According to the input-channels-number, the first to-be-processed data are divided into fourth to-be-processed data set A and fourth to-be-processed data set B, wherein the fourth to-be-processed data set A includes the first channel data and the second channel data, and the fourth to-be-processed data set B includes the third channel data. An optimal data set is selected from the first channel data so as to obtain fourth channel data. An optimal data set is selected from the second channel data so as to obtain fifth channel data. An optimal data set is selected from the third channel data so as to obtain sixth channel data. The fourth channel data and the fifth channel data are taken as one data group, and the sixth channel data is taken as another data group.

In a manner of selecting the optimal data set from an individual channel of data in the first to-be-processed data, it is determined that the optimal data set selected from the individual channel of data contains k columns of data, and further, a height of the optimal data set is determined according to the data processing volume threshold of the chip and data volume of the k columns of data, wherein k is a positive integer. For example, assuming that k=6 and the data processing volume threshold of the chip is 8 kilobytes, in a case that a data set with a size of 6*4 (that is, 6 rows and 4 columns) is selected from the individual channel of data in the first to-be-processed data is of a data volume 7.4 kilobytes, and a data set with a size of 7*4 (that is, 7 rows and 4 columns) selected from the first to-be-processed data is of a data volume 8.2 kilobytes, it is determined that a data set with a size of 6*4 selected from the individual channel of data in the first to-be-processed data is the optimal data set from the individual channel of data.

In another manner to select an optimal data set from an individual channel of data in the first to-be-processed data, it can be determined that the optimal data set selected from the individual channel of data contains t rows of data, and further, a width of the optimal data set can be determined according to the data processing volume threshold of the chip and data volume of t data, wherein t is a positive integer. For example, assuming that t=5, and a data processing volume threshold of the chip is 8 kilobytes, in a case that the data set with a size of 5*4 (that is, 5 rows and 4 columns) selected from the individual channel of data in the first to-be-processed data is of a data volume 7.4 kilobytes, and a data set with a size of 5*5 (that is, 5 rows and 5 columns) selected from the first to-be-processed data is of a data volume 8.2 kilobytes, it is determined that a data set with a size of 5*4 selected from the individual channel of data in the first to-be-processed data is the optimal data set of the individual channel of data.

Since data volume of each channel of the second to-be-processed data obtained by dividing the first to-be-processed data according to the technical solution of the embodiment is less than the data processing volume threshold, the chip can process the second to-be-processed data in one processing batch. In this way, while the chip is processing the second to-be-processed data, the chip can still read data from external memory, thereby improving the reading efficiency of the chip.

For example, the first to-be-processed data contains two channels of data, and second to-be-processed data A and second to-be-processed data B can be obtained through dividing first channel data of the first to-be-processed data according to the technical solution provided in this embodiment, and second to-be-processed data C and second to-be-processed data D can be obtained by dividing second channel data of the first to-be-processed data according to the technical solution provided in this embodiment. Assuming that the number of input channels of the chip is 1, the chip calls processing resources to process the second to-be-processed data A, and while the chip processes the second to-be-processed data A, the cache of the chip reads the second to-be-processed data B from the external memory. After the chip completes processing on the second to-be-processed data A, the chip processes the second to-be-processed data B stored in the cache. While the chip processes the second to-be-processed data B, the cache of the chip reads the second to-be-processed data C from the external memory. Similarly, while the chip processes the second to-be-processed data C, the cache of the chip reads the second to-be-processed data D from the external memory.

302. The at least two data groups are determined as the second to-be-processed data.

In the embodiment, the first to-be-processed data is divided according to the data processing volume threshold of the chip and the input-channels-number, so as to obtain the second to-be-processed data. While the channels-number of the second to-be-processed data is kept less than or equal to the input-channels-number, the data volume of the second to-be-processed data can be as close as possible to the data processing volume threshold of the chip, thereby making full use of the processing resources of the chip and improving the processing efficiency of the chip. In addition, while processing the second to-be-processed data, the hardware resources of the chip in an idle state can also be cut down, thereby improving the reading efficiency of the chip in the processing of the second to-be-processed data.

In a case that the data volume of each channel of data of the first to-be-processed data is greater than the data processing volume threshold of the chip, the technical solution according to the embodiment is applied to divide each channel of data of the first to-be-processed data so as to obtain input data of each channel of the chip, such that the processing efficiency and the reading efficiency of the chip can be improved. However, in the actual application with convolutional neural networks, data volume of each channel of data of the first to-be-processed data may be less than the data processing volume threshold of the chip. At this time, input data that can make full use of the processing resource of the chip cannot be obtained through the technical solutions according to the above embodiments. To this end, embodiments of the present disclosure further provide a method of processing the first to-be-processed data. As an optional embodiment, the implementation manner of step 102 may be:

first channel data and second channel data of the first to-be-processed data are spliced so as to obtain a second to-be-processed data.

In this step, the first to-be-processed data includes at least two channels of data.

As data volume of each channel of the first to-be-processed data is less than the data processing volume threshold of the chip, in a case that a channel of data of the first to-be-processed data is directly taken as input data of an individual channel of the chip, the processing resources of the chip will not be fully utilized, resulting in low processing efficiency of the chip. For this reason, in this embodiment, at least two channels of data are spliced so as to obtain input data that can fully utilize the processing resources of the chip.

Taking splicing first channel data and second channel data of the first to-be-processed data as an example, the first channel data and the second channel data are laterally spliced so as to obtain fifth to-be-processed data, wherein data volume of the fifth to-be-processed data is greater than or equal to the data processing volume threshold of the chip. The fifth to-be-processed data is taken as a channel of data in the second to-be-processed data.

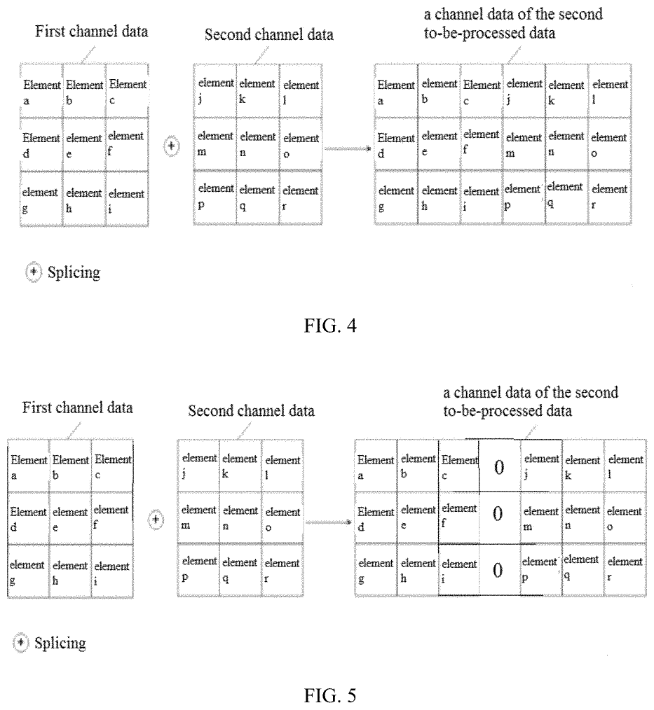

For example, data volume of the first channel data and data volume of the second channel data are both 5 kilobytes, and the data processing volume threshold of the chip is 8 kilobytes. As illustrated in FIG. 4, the first channel data and the second channel data are laterally spliced so as to obtain a spliced data with data volume of 10 kilobytes, which is taken as a channel of data in the second to-be-processed data. The width of the spliced data (the number of columns) is a sum of the width of the first channel data (i.e. the number of columns) and the width of the second channel data (i.e. the number of columns), and the height of the spliced data (i.e. the number of rows) is a sum of the height of the first channel data (i.e. the number of rows) and the height of the second channel data (i.e. the number of rows).

It should be understood that, in the foregoing example, the first channel data and the second channel data, as objects to be spliced, are spliced so as to obtain a channel of data in the second to-be-processed data. In practical applications, 3 or more channels of data can also be spliced to obtain one channel of data in the second to-be-processed data. The present disclosure does not limit the number of channel data to be spliced.

Optionally, as described above, information of data adjacent to the data on which a convolution operation is performed is required in case of performing convolution operation. For example, when performing a convolution operation on the data e of the first channel of the second to-be-processed data illustrated in FIG. 4, information of data a, information of data b, information of data c, information of data d, information of data f, information of data g, information of data h, and information of data i are required. Therefore, in order to facilitate subsequent convolution operation on the second to-be-processed data, in a case of splicing the first channel data and the second channel data, bits may be filled between the first channel data and the second channel data so as to separate the first channel data from the second channel data. As illustrated in FIG. 5, 0 is filled between the first channel data and the second channel data, so as to obtain a channel of data in the second to-be-processed data.

It should be understood that the size (3*3) of the first channel data and the second channel data illustrated in FIG. 4 and FIG. 5 are just an example according to the embodiment of the present disclosure, and should not be construed as a limit to the present disclosure. In practical applications, data of any size can be spliced.

What are described above is that at least two channels of data in the first to-be-processed data are spliced so as to obtain a channel of data in the second to-be-processed data. In actual processing, at least two channels of data in the second to-be-processed data can be obtained by splicing at least two channels of data in the first to-be-processed data. For example, the first to-be-processed data includes 4 channels of data, namely: first channel data, second channel data, third channel data, and fourth channel data. The input-channels-number is 2. The first channel data and the second channel data are spliced so as to obtain fifth channel data. The third channel data and the fourth channel data are spliced so as to obtain sixth channel data. The fifth channel data is taken as one channel of data in the second to-be-processed data, and the sixth channel data is taken as another channel of data in the second to-be-processed data, that is, the second to-be-processed data contains 2 channels of data.

In this embodiment, at least one channel of data in the second to-be-processed data are obtained by splicing at least two channels data, thereby improving the processing efficiency of the chip.

In a case that data volume of the fifth to-be-processed data which is obtained through splicing, is greater than the data processing volume threshold of the chip, the fifth to-be-processed data may be divided so as to select an optimal data set from the fifth to-be-processed data, so that data volume of the divided data is less than or equal to the data processing volume threshold of the chip, thereby fully utilizing the processing resources of the chip and improving the processing efficiency of the chip.

It should be understood that the implementation of splicing the at least two channels of data is not only applicable to the case where data volume of each channel of the first to-be-processed data is less than the data processing volume threshold of the chip. In a case that data volume of each channel of the first to-be-processed data is greater than the data processing volume threshold of the chip, at least two channels of data can also be spliced so as to obtain a channel of data in the second to-be-processed data, thereby improving the processing efficiency of the chip.

For example, assuming that the data processing volume threshold of the chip is 9 kilobytes, a size of each channel of data in the first to-be-processed data is 5*4 (that is, 4 rows and 4 columns), and data volume of each channel of the first to-be-processed data is 10 kilobytes. A data block with a size of 4*4 (that is, 4 rows and 4 columns) in each channel of data in the first to-be-processed data is of a data volume 8 kilobytes. A data block with a size of 3*4 (that is, 3 rows and 4 columns) in the each channel of data in the first to-be-processed data is of a data volume 6 kilobytes. In a case that each channel of data in the first to-be-processed data is directly divided, without splicing at least two channels of data in the first to-be-processed data, two second to-be-processed data, with a size of 4*4 and a size of 1*4, are obtained, wherein data volume of the second to-be-processed data with a size of 1*4 is 2 kilobytes. If the two channels of data in the first to-be-processed data are spliced, fifth to-be-processed data with a size of 5*8 (that is, 5 rows and 8 columns) can be obtained. An optimal data set is selected from the fifth to-be-processed data, and two second to-be-processed data with a size of 2*8 (i.e. 2 rows and 8 columns) and one second to-be-processed data with a size of 1*8 (i.e. 1 row and 8 columns)), wherein data volume of the second to-be-processed data with a size of 2*8 is 8 kilobytes, and data volume of the second to-be-processed data with a size of 1*8 is 4 kilobytes. The processing efficiency of the chip in case of processing the second to-be-processed data with a size of 4*4 is the same as the processing efficiency of the chip in case of processing the second to-be-processed data with a size of 1*8. However, the processing efficiency of the chip in case of processing the second to-be-processed data with a size of 1*8 is higher than that of the chip in case of processing the second to-be-processed data with a size of 1*4.

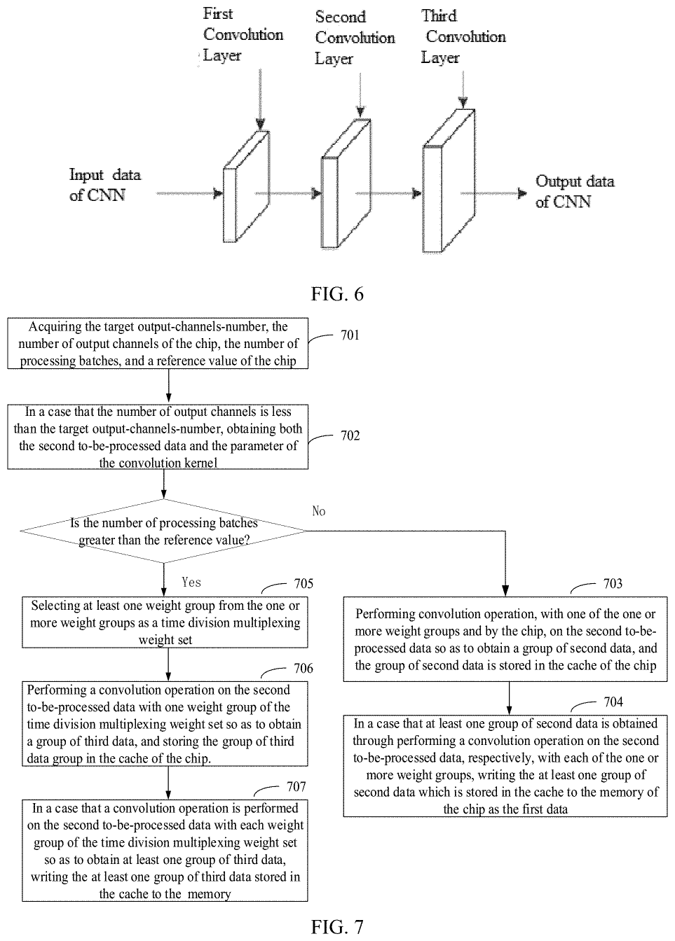

Convolutional layers of a convolutional neural network are usually connected in sequence. As illustrated in FIG. 6, output data of a first convolutional layer is input data of a second convolutional layer, and output data of a second convolutional layer is input data of a third convolutional layer. As the channels-number of the input data of different convolutional layers may be different, it means that the channels-number of data input to a convolutional layer will be changed after the processing of the convolutional layer. For example, assuming that in the convolutional neural network illustrated in FIG. 6, the channels-number of input data of the first convolutional layer is 3, the channels-number of input data of the second convolutional layer is 4, and the channels-number of the third convolutional layer is 5, then, the channels-number of the input data of the first convolutional layer is changed from 3 to 4, and the channels-number of the input data of the second convolutional layer is changed from 4 to 5.

Similar to the number of input channels of the chip, the number of output channels of the chip is also fixed. Therefore, it is usually impossible to write all the data output from a convolutional layer to the external memory in one processing batch.

For example (Example 2), assuming that the number of output channels of the chip is 2, the channels-number of data input to the second layer of the convolutional neural network as illustrated in FIG. 6 is 4. The chip needs to perform a convolution operation on the data input to the first convolutional layer twice, that is, the chip needs to execute 2 processing batches to complete the processing of the first convolutional layer.

In a case that the chip needs at least two processing batches to complete the processing of a convolutional layer, it means that, in order to complete the processing of a convolutional layer, the chip needs to perform reading operation for at least two times and writing operation for at least two times. This will cause high power consumption, increase delay, and reduce the processing efficiency of the chip. Following example 2, another example (Example 3) is given. Assuming that input data of the first convolutional layer is data A, in a case of executing a first processing batch in the processing of the first convolutional layer, the chip reads the data A and the first weight group from the external memory to the cache, and performs a convolution operation on the data A with the first weight group so as to obtain data B of 2 channels and to write the data B to the external memory. In a case of executing a second processing batch in the processing of the first convolutional layer, the chip reads the data A and a second weight group from the external memory to the cache, and performs a convolution operation on the data A with the second weight group so as to obtain data C of 2 channels and to write the data C to the external memory. In the process of performing the convolution operation on the data A, the chip performs reading operation for two times and writing operation for two times in total.

In order to reduce the power consumption and time delay of the chip, and improve the processing efficiency of the chip, the embodiment of the present disclosure further provides an optimal solution. Please refer to FIG. 7, which illustrates a schematic flowchart of a method of processing data according to another embodiment of the disclosure.

701. The target output-channels-number, the number of output channels of the chip, the number of processing batches, and a reference value of the chip are acquired.

In the embodiment of the present disclosure, the chip includes memory, in which the second to-be-processed data and the parameter of the convolution kernel are stored.

The target output-channels-number is: the channels-number of the input data of a convolutional layer next to a current convolutional layer (such as the first convolutional layer in Example 3).

In the embodiments of the present disclosure, the number of processing batches refers to the number of processing batches that the chip needs to complete the processing on the second to-be-processed data by the current convolutional layer. For example, in a case that the chip needs 2 processing batches to complete the processing on the second to-be-processed data, the number of processing batches is 2.

Before explaining the reference value of the chip, time division multiplexing cycle of the chip is defined first. A time division multiplexing cycle of the chip may include at least one processing batch. The chip may obtain one processing result through one processing batch, and the chip may obtain at least one processing result in one time division multiplexing cycle. In a time-division multiplexing cycle, the chip stores the obtained processing result in the cache, and the chip will not write all the processing results obtained in the time division multiplexing cycle to the memory until all processing batches in the time-division multiplexing cycle are executed. For example, one time division multiplexing cycle of the chip includes 2 processing batches. After the chip obtains a processing result A through a first processing batch, it stores the processing result A in the cache, rather than writing the processing result A to the memory. After the chip obtains a processing result B through the second processing batch, it writes both the processing result A and the processing result B to the memory.

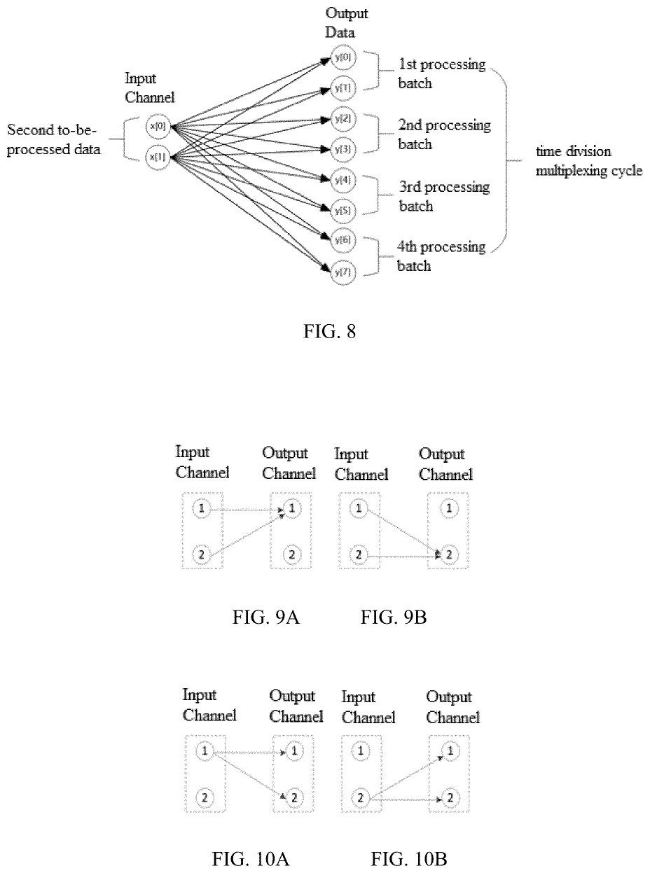

In the embodiment of the present disclosure, the reference value of the chip is defined as a maximum value for the number of processing batches included in one time division multiplexing cycle of the chip. For example, the number of input channels of the chip is 2, and the number of output channels of the chip is 2. The reference value of the chip being 4 means that a time division multiplexing cycle of the chip may include 4 processing batches at most. As illustrated in FIG. 8, a time division multiplexing cycle of the chip mays include 1 processing batch (obtaining data from two channels, namely, y[0] and y[1], through this processing batch), and similarly, the time division multiplexing cycle of the chip may include 2 processing batches (obtaining data from four channels, namely, y[0], y[1], y[2] and y[3], through the 2 processing batches), and the time division multiplexing cycle of the chip can further include 3 processing batches (obtaining data from six channels, namely, y[0], y[1], y[2], y[3], y[4] and y[5], through these 3 processing batches), the time division multiplexing cycle of the chip can further include 4 processing batches (obtaining data from eight channels, namely, y[0], y[1], y[2], y[3], y[4], y[5], y[6] and y[7], through these 4 processing batches).

702. In a case that the number of output channels is less than the target output-channels-number, both the second to-be-processed data and the parameter of the convolution kernel are obtained.

In this embodiment, in a case that the number of output channels of the chip is less than the target output-channels-number, the second to-be-processed data and the parameter of the convolution kernel, stored in the memory, are read into the cache. In this way, before completing processing of a current convolutional layer (for example, the first convolutional layer of Example 3), there is no need to read data from the memory. For example, in a case that the technical solution according to this embodiment is applied to a chip, both the second to-be-processed data and the parameter of the convolution kernel are stored in the memory of the chip. In a case that the chip executes this step, the chip reads both the second to-be-processed data and the parameter of the convolution kernel from the memory to the cache of the chip. In this way, the chip does not need to read data from the memory any more before completing the processing of the current convolutional layer.

The parameter of the convolution kernel include: all weights required by the current convolutional layer to perform convolution on the second to-be-processed data. For example, the parameter of the convolution kernel includes one or more weight groups (hereinafter referred to as z-weight group, where z is the number of processing batches described above).

In a possible embodiment, the number of processing batches may be obtained by rounding up the quotient of the target output-channels-number and the number of output channels of the chip. For example, in a case that the target output-channels-number is 9 and the number of output channels of the chip is 4, the quotient of the target output-channels-number and the number of output channels of the chip is 9/4, and then 9/4 is rounded up to 3, that is, the number of processing batches is 3.

703. In a case that the number of processing batches is less than or equal to the reference value, a convolution operation is performed, with one of the one or more weight groups and by the chip, on the second to-be-processed data so as to obtain a group of second data, and the group of second data is stored in the cache of the chip.

The number of processing batches being less than or equal to the reference value means that the chip can complete the processing on the second to-be-processed data by the current convolutional layer in one time division multiplexing cycle.

The chip performs the convolution operation on the second to-be-processed data with a set of weight among the z sets of weight, so as to complete one processing batch and obtain a group of second data. After obtaining the group of second data, the chip stores the group of second data in the cache, rather than writing the group of second data to the memory.

704. In a case that at least one group of second data is obtained through performing a convolution operation on the second to-be-processed data, respectively, with each of the one or more weight groups, the at least one group of second data which is stored in the cache is written to the memory of the chip as the first data.

As described in step 702, a group of second data may be obtained through performing a convolution operation on the second to-be-processed data with a weight group of the z weight groups. Through performing, with each of the z weight groups, a convolution operation on the second to-be-processed data, the convolution operation on the second to-be-processed data by the current convolutional layer can be completed and z groups of second data can be obtained.

For example (Example 4), the parameter of the convolution kernel includes two weight groups, namely: weight A and weight B. A convolution operation is performed on the second to-be-processed data with weight A so as to obtain second data A, a convolution operation is performed on the second to-be-processed data with weight B so as to obtain second data B.

After obtaining the z groups of second data, the chip writes the z groups of second data which are stored in the cache into the memory as first data.

Following Example 4, another example is given. The chip performs a convolution operation on second to-be-processed data with the weight A so as to obtain second data A and stores the second data A in the cache. And next, the chip performs a convolution operation on the second to-be-processed data with the weight B so as to obtain second data B, and stores the second data B in the cache. Then, the second data A and the second data B are first data which are obtained through performing, by the current convolutional layer, the convolution operation on the second to-be-processed data. After storing the second data B in the cache, the chip writes, to the memory, the second data A and the second data B which are stored in the cache.

It can be seen from Example 4 that, during the chip performing the convolution operation on the second to-be-processed data with the weight A and the weight B, only one reading operation and one writing operation are performed. This reduces power consumption of the chip and improves processing efficiency of the chip.

705. In a case that the number of processing batches is greater than the reference value, at least one weight group is selected from the one or more weight groups as a time division multiplexing weight set.

If the number of processing batches is greater than the reference value, it means that the chip needs at least two time division multiplexing cycles to complete processing on the second to-be-processed data by the current convolutional layer. In order to make full use of the resources of the chip, at least one weight group (hereinafter referred to as an X group) is selected from the z weight groups as a time division multiplexing weight set, so that a convolution operation is performed on the second to-be-processed data with the time division multiplexing weight set subsequently. Here, x is equal to the reference value. For example, in a case that the reference value of the chip is 4 and z=9, 4 weight groups are selected from 9 weight groups as the time division multiplexing weight set.

706. A convolution operation is performed on the second to-be-processed data with one weight group of the time division multiplexing weight set so as to obtain a group of third data, and the group of third data group is stored in the cache of the chip.

The device for processing data performs a convolution operation on the second to-be-processed data with one weight group of the time division multiplexing set, thus, one processing batch is completed and a group of third data is obtained. After obtaining the group of third data, the device for processing data stores the group of third data in the cache of the chip, rather than writing the group of third data to the memory. Optionally, the device for processing data in this step is a chip.

707. In a case that a convolution operation is performed on the second to-be-processed data with each weight group of the time division multiplexing weight set so as to obtain at least one group of third data, the at least one group of third data stored in the cache is written to the above-mentioned memory.

As described in step 706, a group of third data may be obtained through performing the convolution operation on the second to-be-processed data with a weight group of the time division multiplexing weight set. X groups of third data may be obtained through performing a convolution operation on the second to-be-processed data with each weight group of the time division multiplexing weight set. After obtaining the X groups of third data, the chip write the X groups of third data to the memory.

After the chip obtains X groups of third data (that is, x channels of output data) through a time division multiplexing cycle, it also needs to perform a convolution operation on the second to-be-processed data so as to obtain the remaining (z-x) channels of output data.

In a case that (z-x) is less than or equal to x, according to the technical solution provided in steps 703 to 704, a convolution operation is performed on the second to-be-processed data with weights of the z weight groups except the time division multiplexing weight set, until the z channels of output data is obtained, and then the convolution operation on the second to-be-processed data by the current convolutional layer is completed. In a case that (z-x) is greater than x, according to the technical solution provided in steps 705 to 707, the convolution operation is performed on the second to-be-processed data with the weights of the z weight groups except the time division multiplexing weight set, until the z channels of output data are obtained, and then the convolution operation on the second to-be-processed data by the current convolutional layer is completed.

For example, the target output-channels-number is 16, the number of output channels of the chip is 2, the reference value for the chip is 4, and z=8. 8 groups of third data (including third data A, third data B, third data C, third data D, third data E, third data F, third data G and the third data H) may be obtained through the processing of the first time division multiplexing cycle of the chip, as the first 8 channels of data in the target output data. Another 8 groups of third data (including third data I, third data J, third data K, third data L, third data M, third data N, third data O, and third data P) may be obtained through the processing of the second time division multiplexing cycle of the chip, as the last 8 channels of data in the target output data. In the first time division multiplexing cycle, the chip selects 4 weight groups from 8 weight groups as the time division multiplexing weight set for the first time division multiplexing cycle. After obtaining the third data A, the third data B, the third data C, the third data D, the third data E, the three data F, the third data G, and the third data H through completing four processing batches with the time division multiplexing set for the first time division multiplexing cycle, the third data A, the third data B, the third data C, the third data D, the third data E, the three data F, the third data G, and the third data H, which are stored in the cache, are written to the memory for once. In the second time division multiplexing cycle, the chip selects 4 weight groups of the 8 weight groups except the first time division multiplexing weight set, as a time division multiplexing weight set for the second time division multiplexing cycle. After obtaining the third data I, the third data J, the third data K, the third data L, the third data M, the three data N, the third data O, and the third data P through completing four processing batches with the time division multiplexing set for the second time division multiplexing cycle, the third data I, the third data J, the third data K, the third data L, the third data M, the three data N, the third data O, and the third data P, which are stored in the cache, are written to the memory for once. So far, the chip has obtained 16 channels of target output data (that is, the third data A, the third data B, the third data C, the third data D, the third data E, the third data F, the third data Three data G, third data H, third data I, third data J, third data K, third data L, third data M, third data N, third data O, and third data P) through processing of two time division multiplexing cycles.

In the above example, in a case of processing without the technical solution according to this embodiment, it is required to write two groups of third data to the memory for one time after each processing batch. For example, the third data A and the third data B are obtained through the first processing batch of the first time division multiplexing cycle and then are written to the memory. The third data C and the third data D are obtained through the second processing batch of the first time division multiplexing cycle and then are written to the memory. In this way, the chip needs to write data to the memory for 8 times. In a case of processing with the technical solution according to the embodiment, the chip needs to write data to the memory for only 2 times. Clearly, the technical solution of the present embodiment can reduce the times of writing data to the memory by the chip, decrease the power consumption of the chip and improve the processing efficiency of the chip.

Optionally, in this embodiment, the first to-be-processed data includes a first to-be-processed data set, and the second to-be-processed data includes a second to-be-processed data set, and each to-be-processed data sub-set in the first to-be-processed data set has corresponding data in the second to-be-processed data set. For example, the first to-be-processed data set includes first to-be-processed data sub-set A and first to-be-processed data sub-set B. According to the input-channels-number, the first to-be-processed data sub-set A is processed so as to obtain the second to-be-processed data sub-set a and the second to-be-processed data sub-set b. And according to the input-channels-number, the first to-be-processed data sub-set B is processed so as to obtain the second to-be-processed data sub-set c and the second to-be-processed data sub-set d. The second to-be-processed data sub-set a, the second to-be-processed data sub-set b, the second to-be-processed data sub-set c, and the second to-be-processed data sub-set d are taken as the second to-be-processed data set. The second to-be-processed data sub-set a and the second to-be-processed data sub-set b in the second to-be-processed data set are data corresponding to the first to-be-processed data sub-set A, and the second to-be-processed data sub-set c and the second to-be-processed data sub-set d in the second to-be-processed data set are data corresponding to the first to-be-processed data sub-set B.

In a case that the first to-be-processed data set includes at least two data sub-set, the second to-be-processed data set may be obtained through processing the at least two data sub-set. Processing result of the first to-be-processed data set may be obtained through performing a convolution operation on each of the second to-be-processed data sub-sets, respectively, until all of the second to-be-processed data sub-set is processed. For example, the first to-be-processed data set includes an image A and an image B. The channels-number of the image A and the image B is 3, respectively, where the image A contains first channel data, second channel data, and third channel data, and the image B contains fourth channel data, fifth channel data, and sixth channel data. The input-channels-number is 2. Seventh channel data may be obtained through selecting an optimal data set from the first channel data. Eighth channel data may be obtained through selecting an optimal data set from the second channel data. Ninth channel data may be obtained through selecting an optimal data set from the third channel data. Tenth channel data may be obtained through selecting an optimal data set from the fourth channel data. Eleventh channel data may be obtained through selecting an optimal data set from the fifth channel data. Twelfth channel data may be obtained through selecting an optimal data set from the sixth channel data. The seventh channel data and the eighth channel data are taken as the second to-be-processed data sub-set a. The ninth channel data and the tenth channel data are taken as the second to-be-processed data sub-set b. The eleventh channel data and the twelfth channel data are taken as the second to-be-processed data sub-set c. The chip may process the second to-be-processed data sub-set a in the first processing batch so as to obtain processing result 1. The chip may process the second to-be-processed data sub-set b in the second processing batch so as to obtain processing result 2. In the third processing batch, the chip may process the second to-be-processed data sub-set c in the third processing batching so as to obtain processing result 3. All of the processing result 1, the processing result 2, and the processing result 3 are results obtained through performing a convolution operation on the optimal data set of each channel of the first to-be-processed data set. In the same way, data of the first to-be-processed data set except the optimal data set may be processed so as to obtain processing result 4. All of the processing result 1, the processing result 2, the processing result 3, and the processing result 4 are processing results obtained through processing the first to-be-processed data set.

In a case that the number of output channels of the chip is less than the target output-channels-number, in the embodiments of the present disclosure, the results obtained in each processing batch is stored in the cache until processing of a time division multiplexing cycle is completed, then the data stored in the cache is written to the memory for once. Thus, times of writing data to the memory in the process that the chip completes performing a convolution operation on the second to-be-processed data is decreased, thereby reducing the power consumption of the chip and improving the processing efficiency of the chip.

After obtaining the second to-be-processed data, the chip calls a processing resource (such as a computing resource of a convolution processing unit) to perform a convolution operation on the second to-be-processed data. This process can be implemented in any one of following two ways:

1. A convolution operation is performed on the second to-be-processed data with the parameter of the convolution kernel such that all the second to-be-processed data is mapped to one of the output channels of the chip, so as to obtain one channel of data of the first data (hereinafter referred to as fourth data). The operation will be repeated until the chip maps all the second to-be-processed data to respective output channel of the chip.

For example (Example 5), the chip contains 2 input channels. Assume that the second to-be-processed data contains 2 channels of data, which are respectively taken as input data for the 2 input channels of the chip. As illustrated in FIG. 9A, in the first processing batch, the chip may perform a convolution operation on the input data of the channel 1 and the input data of the channel 2 with the weight of the parameter of the convolution kernel such that the input data of the channel 1 and the input data of the channel 2 are mapped to the output channel 1, so as to obtain output data of the output channel 1. As illustrated in FIG. 9B, in the second processing batch, the chip may perform a convolution operation on the input data of the channel 1 and the input data of the channel 2 with the weight of the parameter of the convolution kernel such that the input data of the channel 1 and the input data of the channel 2 are mapped to the output channel 2, so as to obtain output data of the output channel 2. The output data of the output channel 1 and the output data of the output channel 2 are the first data. That is to say, the first data includes 2 channels of data, one channel of data is the output data of the output channel 1 and the other channel of data is the output data of the output channel 2.

2. A convolution operation is performed on the second to-be-processed data with the parameter of the convolution kernel, such that a channel of data in the second to-be-processed data is mapped to respective output channels of the chip, so as to obtain a fifth data which belongs to the first data. The operation described above is repeated until respective channel of data in the second to-be-processed data is mapped to respective channel of the chip, and thus, at least one sixth data is obtained. The fifth data and the at least one sixth data are added, thereby obtaining the first data.

For example (Example 6), the chip contains 2 input channels. Assume that the second to-be-processed data contains 2 channels of data, which are respectively taken as input data of the 2 input channels of the chip. As illustrated in FIG. 10A, in the first processing batch, the chip may perform a convolution operation on input dada of input channel 1 with a weight of the parameter of the convolution kernel, such that the input data of the input channel 1 is mapped to output channel 1 and output channel 2, respectively, so as to obtain fifth data, wherein the fifth data contains seventh data which belongs to output data of the input channel 1 and eighth data which belongs to output data of the input channel 2. As illustrated in FIG. 10B, in the second processing batch, the chip may perform a convolution operation on input dada of input channel 1 and input data of input channel 2 with a weight of the parameter of the convolution kernel, such that the input data of the input channel 1 and the input data of the input channel 2 are respectively mapped to output channel 1 and output channel 2, respectively, so as to obtain sixth data, wherein the sixth data contains ninth data which belongs to output data of the input channel 1 and tenth data which belongs to output data of the input channel 2. The seventh data in the fifth data and the ninth data in the sixth data are added so as to obtain output data of the output channel 2. The output data of the output channel 1 and the output data of the output channel 2 are the first data. That is to say, the first data contains 2 channels of data, wherein one channel of data is the output data of the output channel 1 and the other channel of data is the output data of the output channel 2.

In the first way, the chip is required to perform reading operation on the second to-be-processed data for one time, and performing reading operation on the weight of the parameter of the convolution kernel for at least one time. As described in Example 5, the weight used in the first processing batch is the weight for mapping data of input channel to the output channel 1, and the weight used in the second processing batch is the weight for mapping data of input channel to the output channel 2. That is, weights used in the two processing batches are different. The input data in the two processing batches are the second to-be-processed data.

In the second way, the chip is required to perform reading operation on the second to-be-processed data for at least one time, and to perform reading operation on the weight of the parameters of the convolution kernel for one time. As described in Example 6, the weights used in the two processing batches both include the weight for mapping the data of the input channel to the output channel 1 and the weight of mapping the data of the input channel to the output channel 2. The input data in the first processing batch is the input data of input channel 1 (that is, one channel of data in the second to-be-processed data), and the input data in the second processing batch is the input data of input channel 2. (That is, another channel of data in the second to-be-processed data).

Since the data volume of one channel in the second to-be-processed data is greater than the data volume of the weight of the parameter of the convolution kernel, the reading efficiency of the chip in the first way is greater than that in the second way. However, storage space of the cache of the chip in the first way is larger than that in the second way, that is, the cost of the chip in the first way is higher than that in the second way.

Since the data volume of the first to-be-processed data is relatively large, and the storage space of the cache of the chip is small, the chip usually requires an external memory, which is configured to store the first to-be-processed data and the parameters of the convolution kernel.

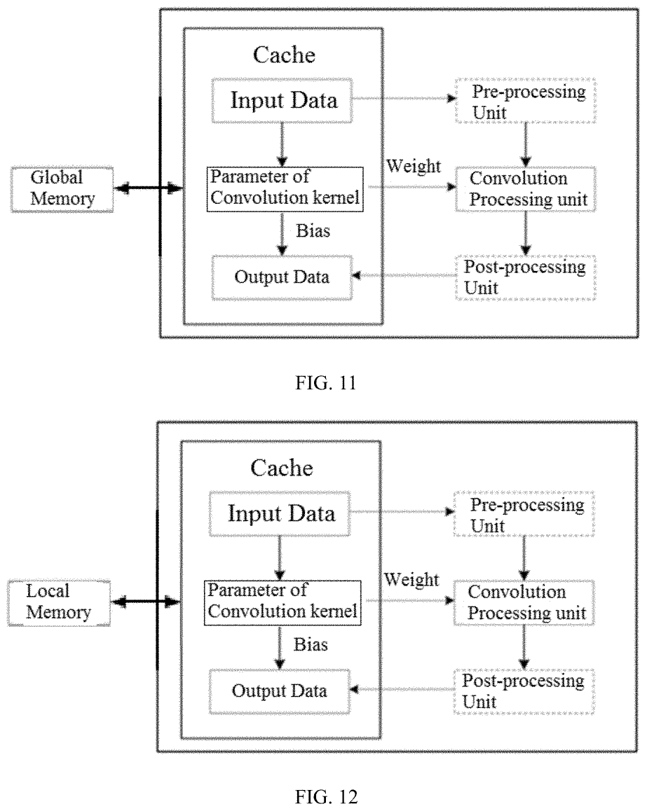

In a possible embodiment, as illustrated in FIG. 11, the memory includes a global memory, which may be accessed by the chip and by hardware other than the chip. For example, the chip belongs to a terminal (such as a computer, a server), and the global memory may be accessed by the chip and also by a CPU of the terminal. Then, the first to-be-processed data and the parameter of the convolution kernel are stored in the global memory.

In another possible embodiment, as illustrated in FIG. 12, the memory includes a local memory, which can only be accessed by the chip. For example, the chip belongs to a terminal (such as a computer, a server), and the local memory can only be accessed by the chip, and hardware other than the chip (such as the CPU of the terminal) cannot access the local memory. Then, the first to-be-processed data and the parameter of the convolution kernel are stored in the global memory.

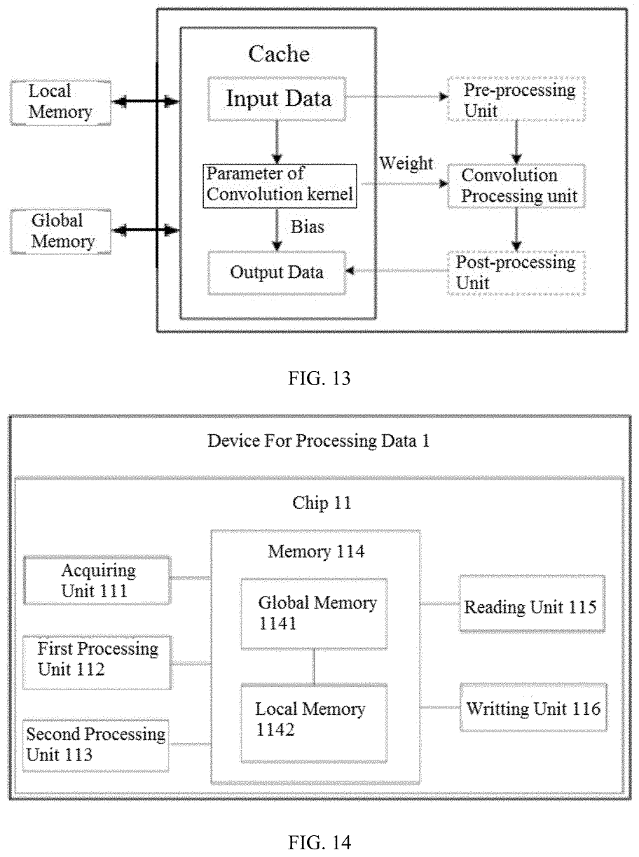

In another possible embodiment, as illustrated in FIG. 13, the memory includes a global memory and a local memory, the global memory can be accessed by the chip and by hardware other than the chip, the local memory can be accessed by the chip and cannot be accessed by hardware other than the chip.

At this time, the first to-be-processed data and the parameter of the convolution kernel can be stored in any one of following 4 storage methods:

1. Both the second to-be-processed data and the parameter of the convolution kernel can be stored in the global memory.

2. The second to-be-processed data and the parameter of the convolution kernel can be stored in the local memory, as well.

3. The second to-be-processed data is stored in the global memory, while the parameter of the convolution kernel is stored in the local memory.

4. The second to-be-processed data is stored in the local memory, while the parameter of the convolution kernel is stored in the global memory.

In the above three possible embodiments, since the global memory can be accessed by not only the chip, but also hardware other than the chip, while the local memory can only be accessed by the chip, the chip accesses the local memory faster than the global memory. However, adding local memory will increase the cost of terminals (such as computers and servers) that contain chips. In actual applications, users can select an appropriate storage manner according to cost and their own needs (such as the processing speed of the chip), which is not limited in the present disclosure.

Optionally, before implementing the technical solutions provided in the embodiments of the present disclosure, the convolutional neural network may be compiled by a CPU to obtain preset data. The preset data carries at least one of following information: the channels-number of input data for each convolutional layer of the convolutional neural network (that is, the input-channels-number of the first to-be-processed data), data volume of respective channel of input data for each convolutional layer of the convolution neural network, data processing volume threshold of the chip, the number of input channels of the chip, the number of output channels of the chip, the reference value for the chip, the target output channel data, the number of processing batches. In addition, the second to-be-processed data is obtained through processing the first to-be-processed data (for example, the implementation of step 102, the implementation of steps 301 to 302) before the chip processes the second to-be-processed data. The preset data may further carry storage address information of the second to-be-processed data. In this way, the second to-be-processed data according to the storage address information of the second to-be-processed data when the chip performs processing on the second to-be-processed data. The preset data can further carry storage address information of the processing parameters. Optionally, both the storage address information of the second to-be-processed data and the storage address information of the processing parameter may be stored in the global memory or the local memory in the form of a linear list. The linear list includes: a linked list. In the case that both the storage address information of the second to-be-processed data and the storage address information of the processing parameters are stored in the global memory or the local memory in the form of a linked list, the second to-be-processed data may be read from the global memory or the local memory according to an address of a node of the linked list, and further, the parameter of the convolution kernel may also be read from the global memory or the local memory according to an address of a node of the linked list. Thereby, allocation of the global memory is more flexible, and allocation of the local memory is more flexible.

Based on the technical solutions according to the embodiments of the present disclosure, the embodiments of the present disclosure also provide several possible application scenarios.

Scenario 1: With the development of deep learning technology, the function of deep convolutional neural network is getting more and more powerful, and more and more application fields, including the field of autonomous driving, are involved.

In the field of autonomous driving, artificial intelligence (AI) chips mounted on vehicles can process road conditions images collected by the vehicle's camera so as to obtain control information such as vehicle speed and steering angle. Furthermore, the movement of the vehicle may be controlled based on the vehicle speed and the steering angle for autonomous driving.

For example, the on-board AI chip of a vehicle a performs a convolution operation on the road condition image through a deep convolutional neural network to extract semantic information of the road condition image. Furthermore, the speed of the vehicle and the steering angle may be obtained according to the semantic information of the road condition image and based on a control mapping relationship (which reflects a mapping relation between the semantic information of the road condition image and the speed of the vehicle and/or the steering angle, and is learned by the deep convolution neural network in a training process). It should be understood that, the speed of the vehicle may be obtained in a case that the control mapping relationship includes a mapping relationship between the semantic information of the road condition image and the speed of the vehicle, and the steering angle of the vehicle may be obtained in a case that the control mapping relationship includes a mapping relationship between the semantic information of the road condition image and the steering angle of the vehicle.

Since AI chips mounted on different vehicles may be different, and the technical solutions according to the embodiments of the present disclosure are highly versatile, and speed of any vehicle-mounted AI chip processing road condition images through a deep convolution neural network can be improved through the technical solutions according to the embodiments of the present disclosure. For example, in the process of reading a road condition image by the car AI chip, the road condition image may be divided according to the number of input channels of the on-board AI chip and the data processing volume threshold of the on-board AI chip, and the deep convolutional neural network can perform a convolution operation on the divided the image.

Scenario 2: With the strengthening of security management awareness of governments, enterprises, and individuals and the popularization of smart hardware devices, more and more access control devices with face recognition functions are put into practical applications. The access control device collects a face image of a visitor through the camera as an image to be recognized. An AI chip of the access control device perform facial feature extraction on the image to be recognized through a deep convolutional neural network so as to obtain facial feature data of the image to be recognized, and then identity of the visitor can be determined based on the facial feature data.

In order to further improve the speed of the A chip performing facial feature extraction on the image to be recognized through the deep convolutional neural network, the AI chip may perform facial feature extraction processing on the image to be recognized through the deep convolutional neural network based on the technical solution according to the embodiments of the present disclosure.

For example, assume that the access control device stores the collected images to be recognized in external memory. When the AI chip reads an image to be recognized from the external memory, the image to be recognized may be divided according to the number of input channels of the AI chip and the data processing volume threshold of the AI chip, and a convolution operation is performed on the divided image through the deep convolutional neural network so as to obtain facial feature data of the image to be recognized. Further, the AI chip can store the facial feature data of the image to be recognized to the external memory based on the technical solutions according to the embodiments of the present disclosure. It should be understood by one of ordinary skill in the art that, in the above methods according to the embodiments, drafting order of the steps does not mean a strict execution order that constitutes any limitation on the implementation process. The execution order of each step should be determined according to the inner logic of its function and possibility.

The methods according to the embodiment of the present disclosure have been discussed in detail, while devices according to the embodiment of the present disclosure will be discussed hereinafter.

Please refer to FIG. 14, which illustrates a schematic structural diagram of a device for processing data 1 according to an embodiment of the disclosure. The device for processing data 1 includes a chip 11 that includes: an acquiring unit 111, a first processing unit 112, and a second processing unit 113, memory 114, a reading unit 115 and a writing unit 116, wherein:

the acquiring unit 111 is configured to acquire first to-be-processed data and the input-channels-number, where the channels-number of the first to-be-processed data is greater than the input-channels-number;

the first processing unit 112 is configured to process the first to-be-processed data according to the input-channels-number so as to obtain second to-be-processed data, wherein the channels-number of the second to-be-processed data is less than or equal to the input-channels-number;

the acquiring unit 111 is further configured to acquire a processing parameter; and

the second processing unit 113 is configured to process the second to-be-processed data with the processing parameter so as to obtain first data.

In a possible embodiment, the processing parameter includes a parameter of the convolution kernel, the device includes a chip, and the input-channels-number is the number of input channels of the chip.

In a possible embodiment, the second processing unit 113 is configured to:

perform a convolution operation on the second to-be-processed data with the parameter of the convolution kernel through the chip 11 so as to obtain the first data.

In a possible embodiment, the first processing unit 112 is configured to:

divide the first to-be-processed data into at least two data groups according to the input-channels-number, the channels-number of each data group is less than or equal to the input-channels-number, and data volume of an individual channel of each data group is less than or equal to data processing volume threshold; and

determine the at least two data groups as the second to-be-processed data.

In a possible embodiment, the first to-be-processed data includes at least two channels of data.

In a possible embodiment, the at least two channels of data include first channel data and second channel data, and the first processing unit 112 is configured to:

splice the first channel data and the second channel data of the first to-be-processed data so as to obtain the second to-be-processed data, wherein the channels-number of the second to-be-processed data is less than or equal to the input-channels-number, and data volume of an individual channel in the second to-be-processed data is less than or equal to the data processing volume threshold.

In a possible embodiment, the first to-be-processed data includes a first to-be-processed data set, and the second to-be-processed data includes a second to-be-processed data set, and each to-be-processed data sub-set in the first to-be-processed data set has corresponding data in the second to-be-processed data set.

In a possible embodiment, the acquiring unit 111 is configured to acquire the target output-channels-number, the number of output channels of the chip, the number of processing batches, and a reference value for the chip;

the second processing unit 113 is configured to:

acquire, in a case that the number of output channels is less than the target output-channels-number, the second to-be-processed data and the parameter of the convolution kernel which includes at least one weight group;

perform, in a case that the number of processing batches is equal to or less than the reference value, a convolution operation on the second to-be-processed data through the chip with one of the at least one weight group, so as to obtain a group of second data, and store the group of second data in a cache of the chip; and

write, in a case that a convolution operation is performed on the second to-be-processed data with each of the at least one weight group so as to obtain at least one group of second data, the at least one group of second data stored in the cache to the memory of the chip as the first data.

In a possible embodiment, the second processing unit 113 is further configured to:

select, in a case that the number of processing batches is greater than the reference value, at least one weight group from the at least one weight groups as a time division multiplexing weight set, wherein the number of weight groups of the time division multiplexing weight set is equal to the reference value; and

perform a convolution operation on the second to-be-processed data set with a weight group of the time division multiplexing weight set so as to obtain a group of third data, and store the group of third data in the cache of the chip.

In a possible embodiment, the second processing unit 113 is further configured to:

write, in a case that at least one group of third data is obtained through performing a convolution operation on the second to-be-processed data set with each weight group of the time division multiplexing weight set, the at least one group of third data stored in the cache to the memory.

In another possible embodiment, the memory 114 includes a global memory 1141 that can be accessed by both the chip 11 and hardware other than the chip 11;

storing both the second to-be-processed data and the parameter of the convolution kernel stored in the memory 114, includes:

storing both the second to-be-processed data and the parameter of the convolution kernel in the global memory 1141.

In another possible embodiment, the memory 114 includes a local memory 1142 that can be accessed by the chip 11 and cannot be accessed by hardware other than the chip 11;

storing both the second to-be-processed data and the parameters of the convolution kernel in the memory 114 includes:

storing both the second to-be-processed data and the parameters of the convolution kernel in the local memory 1142.

In another possible embodiment, the memory 114 includes a global memory 1141 that can be accessed by both the chip 11 and hardware other than the chip 11 and a local memory 1142 that can be accessed by the chip 11 and cannot be accessed by hardware other than the chip 11;

both the second to-be-processed data and the parameters of the convolution kernel stored in the memory 114 includes:

storing the second to-be-processed data and the parameter of the convolution kernel in the global memory 1141; or,

storing the second to-be-processed data and the parameter of the convolution kernel in the local memory 1142; or,

storing the second to-be-processed data in the global memory 1141, and storing the parameters of the convolution kernel in the local memory 1142; or,

storing the second to-be-processed data in the local memory 1142, and storing the parameter of the convolution kernel in the global memory 1141.

In another possible embodiment, the second processing unit 113 is configured to:

perform a convolution operation on the second to-be-processed data with the parameter of the convolution kernel such that all the second to-be-processed data is mapped to one of the output channels of the chip so as to obtain fourth data which is a channel of data in the first data; or

perform a convolution operation on the second to-be-processed data with the parameter of the convolution kernel such that a channel of data in the second to-be-processed data is mapped to each output channel of the chip, respectively, so as to obtain fifth data which belongs to the first data.

Benefiting from processing of input data according to the input channel of the device for processing data, the device for processing data can process input data with different numbers of channels, and the device for processing data according to the embodiment has good versatility.

In some embodiments, the functions or modules of the device according to the embodiments of the present disclosure can be used to perform the methods described in the above method embodiments. Specific implementation may be referred to the description of the above method embodiments and will not be elaborated herein for conciseness.

It should be noted by one of ordinary skill in the art that, the units and the steps of algorithm in the examples described in combination with the embodiments of the present disclosure may be implemented by electronic hardware, computer software, or combination thereof. Whether the functions are implemented by electronic hardware and by software is depended on specific application of the technical solution and design restrictions. One of ordinary skill in the art may adopt various manners to implement the described functions for every specific application, and the implementations also falls into the scope of the present disclosure.

It should be noted by one of ordinary skill in the art that, specific operation process of the systems, the devices, and the units as described above may be referred to corresponding process in the method embodiments as described above, and will not be elaborated herein. It should be further understood by one of ordinary skill in the art that, description of each embodiment of the disclosure has its focus, and same or similar portions are not elaborated in different embodiments. Thus, a portion of some embodiment, which is not described or not described in detail, may be referred to the recordation in other embodiments.

It is should be learned from the embodiments of the present disclosure that, the disclosed systems, devices and methods may be implemented in other manners. For example, the device embodiments as described above are only illustrative. For example, division of the units is just logic function division, and there are other divisions upon implementation. For example, several units or components may be combined or may be integrated into another system, or some features may be ignored, or may not be performed. Additionally, mutual coupling, direct coupling, or communication connection that are discussed or illustrated may be via some interfaces, and indirect coupling or communication connection between devices or units may be electrical, mechanical, or the like.

The unit that is described as a separate component may be or may not by physically separated, the component that is illustrated as a unit may by or may not be a physical unit. That is, the component may be located at a place, or may be distributed over a plurality of network units. Some or all of the units may be selected according to actual requirement so as to achieve the objectives of the solutions of the embodiments.

In addition, the functional units in the various embodiments of the present disclosure may be integrated into one processing unit, or each unit may exist alone physically, or two or more than two units may be integrated into one unit.

In the above embodiments, it may be implemented in whole or in part by software, hardware, firmware or any combination thereof. When implemented by software, it can be implemented in the form of a computer program product in whole or in part. The computer program product includes one or more computer instructions. In a case that the computer program instructions are loaded and executed on the computer, the processes or functions described in the embodiments of the present disclosure are generated in whole or in part. The computer may be a general-purpose computer, a special-purpose computer, a computer network, or other programmable devices. The computer instructions may be stored in a computer-readable storage medium or transmitted through the computer-readable storage medium. The computer instructions can be sent from a website, computer, server, or data center to another website site, computer, server or data center in a wired connection (such as coaxial cable, optical fiber, digital subscriber line (DSL)) or wirelessly (such as infrared, wireless, microwave, etc.). The computer-readable storage medium may be any available medium that can be accessed by a computer or a data storage device including a server or a data center integrated with one or more available media. The available medium may be a magnetic medium (for example, a floppy disk, a hard disk, a magnetic tape), an optical medium (for example, a digital versatile disc (DVD)), or a semiconductor medium (for example, a solid state disk (SSD)) and the like.

It should be understood by one of ordinary skill in the art that all or part of the process in the above-mentioned embodiment method can be implemented by hardware. The process may be completed by a computer program instructing relevant hardware. The computer program may be stored in a computer readable storage medium. The computer program may include, upon execution, the processes of the foregoing method embodiments. The aforementioned storage media include: a read-only memory (ROM) or a random access memory (RAM), a magnetic disk or an optical disk, and various media that can store program codes.

What is claimed is:

1. A method of processing data, comprising:
acquiring first to-be-processed data and an input-channels-number, wherein a channels-number of the first to-be-processed data is greater than the input-channels-number;
processing the first to-be-processed data according to the input-channels-number to obtain second to-be-processed data, wherein a channels-number of the second to-be-processed data is less than or equal to the input-channels-number;
obtaining a processing parameter; and
processing the second to-be-processed data with the processing parameter to obtain first data.

2. The method according to claim 1, wherein
the processing parameter comprises a parameter of a convolution kernel,
the method is applicable to a chip, and the input-channels-number is a number of input channels of the chip.

3. The method according to claim 2, wherein processing the second to-be-processed data with the processing parameter to obtain the first data comprises:
performing, by the chip, a convolution operation on the second to-be-processed data with the parameter of the convolution kernel to obtain the first data.

4. The method according to claim 2, wherein
the first to-be-processed data comprises a first to-be-processed data set,
the second to-be-processed data comprises a second to-be-processed data set, and
each to-be-processed data sub-set in the first to-be-processed data set has corresponding data in the second to-be-processed data set.

5. The method according to claim 3, wherein
the first to-be-processed data comprises a first to-be-processed data set,
the second to-be-processed data comprises a second to-be-processed data set, and
each to-be-processed data sub-set in the first to-be-processed data set has corresponding data in the second to-be-processed data set.

6. The method according to claim 5, wherein performing, by the chip, a convolution operation on the second to-be-processed data with the parameter of the convolution kernel to obtain the first data, comprises:
acquiring a target output-channels-number, a number of output channels of the chip, a number of processing batches, and a reference value of the chip;
acquiring, in a case that the number of output channels is less than the target output-channels-number, the second to-be-processed data and the parameter of the convolution kernel, wherein the parameter of the convolution kernel comprises one or more weight groups;
in a case that the number of processing batches is less than or equal to the reference value,
performing, by the chip, a convolution operation on the second to-be-processed data with one of the one or more weight groups to obtain a group of second data, and
storing the group of second data in a cache of the chip; and
writing, in a case that a convolution operation is performed on the second to-be-processed data with each of the one or more weight groups and at least one group of second data is obtained, the at least one group of second data stored in the cache into memory of the chip as the first data.

7. The method according to claim 6, further comprising:
selecting, in a case that the number of processing batches is greater than the reference value, at least one weight group from the one or more weight groups as a time division multiplexing weight set, a number of weight groups in the time division multiplexing weight set is equal to the reference value;
performing a convolution operation on the second to-be-processed data set with one weight group in the time division multiplexing weight set to obtain a group of third data; and
storing the group of third data in the cache of the chip.

8. The method according to claim 5, further comprising:
selecting, in a case that the number of processing batches is greater than the reference value, at least one weight group from the one or more weight groups as a time division multiplexing weight set, a number of weight groups in the time division multiplexing weight set is equal to the reference value;
performing a convolution operation on the second to-be-processed data set with one weight group in the time division multiplexing weight set to obtain a group of third data; and
storing the group of third data in the cache of the chip.

9. The method according to claim 8, further comprising:
writing, in a case that at least one group of third data is obtained by performing a convolution operation on the second to-be-processed data set with each weight group in the time division multiplexing weight set, the at least one group of third data stored in the cache into the memory.

10. The method according to claim 2, wherein processing the first to-be-processed data according to the input-channels-number to obtain the second to-be-processed data comprises:
dividing the first to-be-processed data into at least two data groups according to the input-channels-number, wherein
a channels-number of each of the at least two data groups is less than or equal to the input-channels-number, and
a data volume of an individual channel in each of the at least two data groups is less than or equal to a data processing volume threshold; and
determining the at least two data groups as the second to-be-processed data.

11. The method according to claim 2, wherein the first to-be-processed data comprises at least two channels of data.

12. The method according to claim 1, wherein processing the first to-be-processed data according to the input-channels-number to obtain the second to-be-processed data comprises:
dividing the first to-be-processed data into at least two data groups according to the input-channels-number, wherein
a channels-number of each of the at least two data groups is less than or equal to the input-channels-number, and
a data volume of an individual channel in each of the at least two data groups is less than or equal to a data processing volume threshold; and
determining the at least two data groups as the second to-be-processed data.

13. The method according to claim 1, wherein the first to-be-processed data comprises at least two channels of data.

14. The method according to claim 13, wherein the at least two channels of data comprises first channel data and second channel data, and processing the first to-be-processed data according to the input-channels-number to obtain the second to-be-processed data comprises:
splicing the first channel data with the second channel data to obtain the second to-be-processed data, wherein
the channels-number of the second to-be-processed data is less than or equal to the input-channels-number, and
a data volume of an individual channel of the second to-be-processed data is less than or equal to a data processing volume threshold.

15. An electronic apparatus, comprising:
a chip;
a processor; and
memory, configured to store computer program code which comprises computer instructions;
wherein, in a case that the chip executes the computer instructions, the electronic apparatus is configured to perform operations comprising:
acquiring first to-be-processed data and an input-channels-number, wherein a channels-number of the first to-be-processed data is greater than the input-channels-number;
processing the first to-be-processed data according to the input-channels-number to obtain second to-be-processed data, wherein a channels-number of the second to-be-processed data is less than or equal to the input-channels-number;
obtaining a processing parameter; and
processing the second to-be-processed data with the processing parameter to obtain first data.

16. The electronic apparatus according to claim 15, wherein processing the first to-be-processed data according to the input-channels-number to obtain the second to-be-processed data comprises:
dividing the first to-be-processed data into at least two data groups according to the input-channels-number, wherein
a channels-number of each of the at least two data groups is less than or equal to the input-channels-number, and
a data volume of an individual channel in each of the at least two data groups is less than or equal to a data processing volume threshold; and
determining the at least two data groups as the second to-be-processed data.

17. The electronic apparatus according to claim 15, wherein the first to-be-processed data comprises at least two channels of data.

18. The electronic apparatus according to claim 17, wherein the at least two channels of data comprises first channel data and second channel data, and processing the first to-be-processed data according to the input-channels-number to obtain the second to-be-processed data comprises:
splicing the first channel data with the second channel data to obtain the second to-be-processed data, wherein
the channels-number of the second to-be-processed data is less than or equal to the input-channels-number, and
a data volume of an individual channel of the second to-be-processed data is less than or equal to a data processing volume threshold.

19. A chip, configured to perform the method according to claim 1.

20. A computer-readable storage medium, wherein a computer program which comprises program instruction is stored in the computer-readable storage medium, in a case that the program instructions are executed by a processor of an electronic apparatus, the processor performs operations comprising:
acquiring first to-be-processed data and an input-channels-number, wherein a channels-number of the first to-be-processed data is greater than the input-channels-number;
processing the first to-be-processed data according to the input-channels-number to obtain second to-be-processed data, wherein a channels-number of the second to-be-processed data is less than or equal to the input-channels-number;
obtaining a processing parameter; and
processing the second to-be-processed data with the processing parameter to obtain first data.
